(19) United States
(12) Patent Application Publication
(10) Pub. No.: US 2022/0024806 A1
(43) Pub. Date: Jan. 27, 2022

(54) NON-ALKALI GLASS

(71) Applicant: Nippon Electric Glass Co., Ltd., Shiga (JP)

(72) Inventors: Atsuki SAITO, Shiga (JP); Masahiro HAYASHI, Shiga (JP)

(73) Assignee: Nippon Electric Glass Co., Ltd., Shiga (JP)

(21) Appl. No.: 17/311,451

(22) PCT Filed: Dec. 6, 2019
(86) PCT No.: PCT/JP2019/047809

§ 371 Date: Jun. 7, 2021

(30) Foreign Application Priority Data
Dec. 10, 2018 (JP) 2018-230609
May 13, 2019 (JP) 2019-090655

(51) Int. Cl. C03C 3/097

(52) U.S. Cl. CPC C03C 3/097

(57) ABSTRACT

An alkali-free glass sheet of the present invention includes as a glass composition, in terms of mol %, 60% to 90% of SiO₂, 5% to 20% of Al₂O₃, 0% to 15% of B₂O₃, 0.1% to 20% of P₂O₅, 0% to 0.5% of Li₂O+Na₂O+K₂O, 0% to 10% of MgO, 0.1% to 10% of CaO, and 0% to 5% of SrO, and has an average thermal expansion coefficient in a temperature range of from 30° C. to 380° C. of 34.0×10⁷/° C. or less.

### TECHNICAL FIELD

The present invention relates to an alkali-free glass sheet, and more particularly, to an alkali-free glass sheet suitable as a substrate for forming a thin film transistor (TFT) circuit in a flat panel display, such as a liquid crystal display or an OLED display, or as a substrate for holding a resin substrate for forming the TFT circuit.

### BACKGROUND ART

As is well known, a liquid crystal panel or an OLED panel includes a TFT for driving control.

As a TFT configured to drive a display, amorphous silicon, low-temperature polysilicon, high-temperature polysilicon, and the like have been known. In recent years, along with the spread of large liquid crystal displays, smartphones, tablet PCs, and the like, there is an increasing need for higher resolution of a display. Also in VR devices and the like, which have attracted attention in recent years, there is an increasing need for still higher resolution.

A low-temperature polysilicon TFT or a high-temperature polysilicon TFT can meet the above-mentioned needs, but a technology for forming such TFT requires a high-temperature process of from 500° C. to 600° C. (e.g., film forming treatment for forming the TFT). However, a related-art alkali-free glass sheet causes pattern deviation of the TFT owing to thermal shrinkage before and after the high-temperature process, or a temperature distribution at the time of heat treatment.

### CITATION LIST

Patent Literature 1: JP 5769617 B2

### SUMMARY OF INVENTION

### Technical Problem

In order to reduce the pattern deviation caused by the alkali-free glass sheet, it is important to achieve both a low thermal shrinkage amount and low thermal expansion at high levels.

As a main method of reducing the thermal shrinkage of the alkali-free glass sheet, two methods are given. A first method is a method involving holding glass in advance around a process temperature for a certain time to anneal the glass. In this method, the glass is relaxed to an equilibrium structure at the process temperature and shrinks during the annealing, and hence the thermal shrinkage amount of the glass in the subsequent film forming treatment can be reduced. However, this method inevitably requires an annealing step, and a manufacturing time is prolonged accordingly, resulting in a rise in manufacturing cost of the alkali-free glass sheet.

The other method is a method involving increasing the strain point of the glass. In an overflow down-draw method, which is one kind of methods of forming a glass sheet, the glass is generally cooled from a melting temperature to a forming temperature in a short time. Under the influence of this, the fictive temperature of the glass sheet is increased, and hence a difference from a film forming temperature is increased, resulting in an increase in thermal shrinkage amount of the glass. In view of the foregoing, when the strain point of the glass is increased, the viscosity of the glass at the film forming temperature is increased, with the result that structural relaxation hardly proceeds. As a result, the thermal shrinkage of the glass can be reduced.

In addition, as a heat treatment temperature becomes higher, an increase in strain point contributes more to a reduction in thermal shrinkage amount. Accordingly, in the case of assuming the high-temperature polysilicon TFT, that is, achieving an increase in definition of a display, an alkali-free glass sheet having a high strain point is required. In Patent Literature 1, there is disclosed a high-strain-point glass including Y₂O₃ and/or La₂O₃. However, Y₂O₃ and La₂O₃, which are rare earth oxides, are rare, and raw materials for introducing Y₂O₃ and La₂O₃ are expensive. This results in a rise in manufacturing cost of the alkali-free glass sheet. Further, when Y₂O₃ and/or La₂O₃ is introduced in a glass composition, there is a risk in that a thermal expansion coefficient may be increased inappropriately.

In addition, in manufacturing of the low-temperature polysilicon TFT, the thermal expansion coefficient of the alkali-free glass sheet can be corrected by adjusting conditions of a film forming apparatus, and hence has not hitherto been regarded as a major problem. However, in the fields of VR devices and the like, pattern deviation caused by a temperature distribution in the film forming apparatus is also regarded as a problem. Accordingly, when a panel having still higher definition is to be manufactured, an alkali-free glass sheet showing lower expansion than in the related art is required.

The present invention has been made in view of the above-mentioned circumstances, and a technical object of the present invention is to devise an alkali-free glass sheet having a high strain point and a low thermal expansion coefficient while preventing a rise in manufacturing cost.

### Solution to Problem

The inventor of the present invention has made extensive investigations, and as a result, has found that the above-mentioned technical object can be achieved by introducing P₂O₅ as an essential component, and strictly restricting the contents of other components. The finding is proposed as the present invention. That is, according to one embodiment of the present invention, there is provided an alkali-free glass sheet, comprising as a glass composition, in terms of mol %, 60% to 90% of SiO₂, 5% to 20% of Al₂O₃, 0% to 15% of B₂O₃, 0.1% to 20% of P₂O₅, 0% to 0.5% of Li₂O+Na₂O+K₂O_{, 0}% to 10% of MgO, 0.1% to 10% of CaO, and 0% to 5% of SrO, and having an average thermal expansion coefficient in a temperature range of from 30° C. to 380° C. of 34.0×10⁻⁷/° C. or less. With this configuration, a strain point can be increased and a thermal expansion coefficient can be reduced without a rise in manufacturing cost. As a result, the thermal shrinkage amount of glass before and after a high-temperature process is reduced, and an influence of a temperature distribution in a film forming apparatus can be alleviated, with the result that pattern deviation of a TFT can be remarkably reduced. Herein, “Li₂O+Na₂O+K₂O” refers to the total content of Li₂O, Na₂O, and K₂O. The “average thermal expansion coefficient in a temperature range of from 30° C. to 380° C.” refers to a value measured with a dilatometer.

In addition, it is preferred that the alkali-free glass sheet according to the one embodiment of the present invention have a content of SrO of 1 mol % or less.

In addition, it is preferred that the alkali-free glass sheet according to the one embodiment of the present invention have a content of B₂O₃ of 6 mol % or less.

In addition, it is preferred that the alkali-free glass sheet according to the one embodiment of the present invention have a strain point of 700° C. or more. Herein, the “strain point” refers to a value measured based on a method of ASTM C336.

In addition, the alkali-free glass sheet according to the one embodiment of the present invention has a density of 2.50 g/cm³ or less, an average thermal expansion coefficient in a temperature range of from 30° C. to 380° C. of 34.0×10⁻⁷/° C. or less, a strain point of 700° C. or more, and a Young's modulus of 70 GPa or more. Herein, the “density” may be measured by a well-known Archimedes method, and the “flexural resonance method” may be measured by a well-known flexural resonance method.

### DESCRIPTION OF EMBODIMENTS

In an alkali-free glass sheet of the present invention, the reasons why the contents of the components are limited as described above are described below. In the descriptions of the contents of the components, the expression “%” represents “mol %”.

SiO₂ is a component which forms a glass skeleton, and is also a component which increases a strain point. Further, when the amount of SiO₂ is increased (e.g., 68% or more), a thermal expansion coefficient can be significantly reduced. Accordingly, the content of SiO₂ is preferably 60% or more, 63% or more, 65% or more, 67% or more, 68% or more, 69% or more, or 70% or more, particularly preferably 71% or more. Meanwhile, when the content of SiO₂ is too large, a viscosity at high temperature is increased, and meltability is liable to be reduced. Moreover, an increase in melting cost leads directly to a rise in production cost. Accordingly, the content of SiO₂ is preferably 90% or less, 85% or less, 80% or less, 77% or less, 76% or less, 75% or less, 74% or less, or 73% or less, particularly preferably 72% or less.

Al₂O₃ is a component which forms the glass skeleton, and is also a component which increases the strain point. Further, Al₂O₃ is a component which suppresses phase separation. In particular, P₂O₅ is incorporated as an essential component in the present invention. In this case, when the content of Al₂O₃ is too small, glass is liable to undergo phase separation. Accordingly, the content of Al₂O₃ is preferably 5% or more, 8% or more, 9% or more, 10% or more, 11% or more, or 12% or more, particularly preferably 12.5% or more. Meanwhile, when the content of Al₂O₃ is too large, the glass is liable to devitrify, and an increase in manufacturing cost may be liable to occur. Accordingly, the content of Al₂O₃ is preferably 20% or less, 19% or less, 18% or less, 17% or less, 16% or less, or 15% or less, particularly preferably 14% or less.

P₂O₅ is a component which remarkably reduces the liquidus temperature of an Al-based devitrified crystal while maintaining a high strain point. In the related-art alkali-free glass, the liquidus temperature of the Al-based devitrified crystal, such as mullite, is reduced by optimizing the contents of alkaline earth metal oxides or their ratio. However, the alkaline earth metal oxides each have an effect of increasing the thermal expansion coefficient. Meanwhile, P₂O₅ has an effect of reducing the liquidus temperature of the Al-based devitrified crystal without increasing the thermal expansion coefficient. Accordingly, the content of P₂O₅ is preferably 0.1% or more, 1% or more, 2% or more, 3% or more, or 4% or more, particularly preferably 5% or more. However, when P₂O₅ is incorporated in a large amount, a Young's modulus is reduced excessively, or the glass is liable to undergo phase separation. In addition, there is a risk that P may be diffused from the glass to reduce the performance of a TFT. Accordingly, the content of P₂O₅ is preferably 20% or less, 15% or less, 12% or less, 11% or less, 10% or less, 9% or less, 8% or less, or 7% or less, particularly preferably 6% or less.

The content of Al₂O₃+P₂O₅ is preferably 14% or more, more than 15%, 17% or more, 18% or more, or 19% or more, particularly preferably from 20% to 25%. When the content of Al₂O₃+P₂O₅ is too small, it becomes difficult to maintain a high strain point. The “Al₂O₃+P₂O₅” refers to the total content of Al₂O₃ and P₂O₅.

B₂O₃ is a component which improves the meltability, and increases the liquidus temperature of the Al-based devitrified crystal. Further, B₂O₃ is a component which reduces the thermal expansion coefficient. Accordingly, the content of B₂O₃ is preferably 0% or more, 1% or more, 2% or more, 3% or more, or 4% or more, particularly preferably 5% or more. Meanwhile, when the content of B₂O₃ is too large, the strain point is significantly reduced, or a water content in the glass is significantly increased. As a result, the thermal shrinkage amount of the glass is increased. Accordingly, the content of B₂O₃ is preferably 15% or less, 10% or less, 9% or less, 8% or less, or 7 or less, particularly preferably 6% or less.

The content of P₂O₅—B₂O₃ is preferably −4% or more, −3% or more, −2% or more, −1% or more, more than 0%, 1% or more, 2% or more, or 3% or more, particularly preferably from 4% to 10%. When the content of P₂O₅—B₂O₃ is too large, the Al-based devitrified crystal is liable to precipitate at the time of forming. The “P₂O₅—B₂O₃” refers to a value obtained by subtracting the content of B₂O₃ from the content of P₂O₅.

A value represented by the calculation formula 14.8×[Al₂O₃]−2.2×[B₂O₃]+[MgO]+6.5×([CaO]+[SrO]+[BaO])−11.1×[P₂O₅] in terms of mol % is preferably 110% or more, 120% or more, 130% or more, 140% or more, 150% or more, 160% or more, 170% or more, or 180% or more, particularly preferably 190% or more. When the value is too small, the glass is liable to undergo phase separation. The “[Al₂O₃]” refers to the content of Al₂O₃ in terms of mol %, the “[B₂O₃]” refers to the content of B₂O₃ in terms of mol %, the “[MgO]” refers to the content of MgO in terms of mol %, the “[CaO]” refers to the content of CaO in terms of mol %, the “[SrO]” refers to the content of SrO in terms of mol %, the “[BaO]” refers to the content of BaO in terms of mol %, and the “[P₂O₅]” refers to the content of P₂O₅ in terms of mol %.

MgO is a component which reduces the viscosity at high temperature to improve the meltability, and is also a component which improves devitrification resistance through balance with other components. Further, MgO is a component which remarkably increases a Young's modulus as a mechanical characteristic. When the Young's modulus is high, an effect of reducing pattern deviation can be exhibited in all the manufacturing steps for a TFT. In addition, among alkaline earth metal elements, MgO has the least effect of increasing the thermal expansion coefficient, and hence is suitable in designing low-expansion glass. Accordingly, the content of MgO is preferably 0% or more, 0.1% or more, 1% or more, 2% or more, or 3% or more, particularly preferably 4% or more. Meanwhile, when the content of MgO is too large, the strain point is liable to be reduced, or the balance with other components is lost, with the result that the devitrification resistance is liable to be reduced. Accordingly, the content of MgO is preferably 10% or less, 9% or less, 8% or less, 7% or less, or 6% or less, particularly preferably 5% or less.

In the present invention, P₂O₅ is incorporated as an essential component, and the ratio of a glass forming oxide is high. As a result, the introduction of CaO is essential from the viewpoint of optimizing the devitrification resistance, the meltability, and the Young's modulus. Accordingly, the content of CaO is preferably 0.1% or more, 1% or more, 2% or more, or 3% or more, particularly preferably 3.5% or more. Meanwhile, when the content of CaO is too large, the thermal expansion coefficient is increased, and besides, the strain point is liable to be reduced. Accordingly, the content of CaO is preferably 10% or less, 9% or less, 8% or less, 7% or less, 6% or less, 5% or less, or 4% or less.

SrO is a component which reduces the viscosity at high temperature to improve the meltability, and is also a component which improves the devitrification resistance through balance with other components. Accordingly, the content of SrO is preferably 0% or more, or 0.1% or more, particularly preferably 0.5% or more. Meanwhile, when the content of SrO is too large, the strain point is liable to be reduced. Accordingly, the content of SrO is preferably 5% or less, 4% or less, 3% or less, or 2% or less, particularly preferably 1% or less.

BaO is a component which improves the devitrification resistance through balance with other components. Accordingly, the content of BaO is preferably 0% or more, or 0.5% or more, particularly preferably 1% or more. Meanwhile, when the content of BaO is too large, the thermal expansion coefficient is increased excessively. In addition, the Young's modulus is liable to be reduced. Accordingly, the content of BaO is preferably 10% or less, 5% or less, 4% or less, or 3% or less, particularly preferably 2% or less.

When the total content of SrO and BaO is too small, the devitrification resistance is liable to be reduced. Accordingly, the total content of SrO and BaO is preferably 0% or more, or 0.1% or more, particularly preferably 1% or more. Meanwhile, when the total content of SrO and BaO is too large, the thermal expansion coefficient is increased. Accordingly, the total content of SrO and BaO is preferably 4% or less, 3% or less, or 2% or less, particularly preferably 1% or less.

The total content of MgO, CaO, SrO, and BaO is preferably 12% or less, 10% or less, 9% or less, 8% or less, 7% or less, or 6% or less, particularly preferably 5% or less in order to reduce the thermal expansion coefficient. However, when the alkaline earth metal oxides are hardly included, the glass composition loses its balance, with the result that the devitrification resistance is liable to be reduced, or the glass is liable to undergo phase separation. Accordingly, the total content of MgO, CaO, SrO, and BaO is preferably 0.1% or more, 1% or more, 2% or more, 3% or more, or 4% or more, particularly preferably 5% or more.

The molar ratio MgO/P₂O₅ is preferably 3 or less, 2 or less, 1.5 or less, 0.8 or less, 0.5 or less, or 0.3 or less, particularly preferably from 0.1 to 0.2. When the molar ratio MgO/P₂O₅ is too high, the thermal expansion coefficient is increased excessively. The “MgO/P₂O₅” refers to a value obtained by dividing the content of MgO by the content of P₂O₅.

The molar ratio CaO/P₂O₅ is preferably 5 or less, 4 or less, 3 or less, 2 or less, from 0.01 to 1, or from 0.1 to less than 1, particularly preferably from 0.3 to 0.7. When the molar ratio CaO/P₂O₅ is too high, the thermal expansion coefficient is increased excessively. The “CaO/P₂O₅” refers to a value obtained by dividing the content of CaO by the content of P₂O₅.

The molar ratio SrO/P₂O₅ is preferably 2 or less, 1 or less, 0.8 or less, 0.6 or less, 0.4 or less, 0.2 or less, or 0.1 or less, particularly preferably less than 0.1. When the molar ratio SrO/P₂O₅ is too high, the thermal expansion coefficient is increased excessively. The “SrO/P₂O₅” refers to a value obtained by dividing the content of SrO by the content of P₂O₅.

The molar ratio BaO/P₂O₅ is preferably 2 or less, 1 or less, 0.8 or less, 0.6 or less, 0.4 or less, 0.2 or less, or 0.1 or less, particularly preferably less than 0.1. When the molar ratio BaO/P₂O₅ is too high, the thermal expansion coefficient is increased excessively. The “BaO/P₂O₅” refers to a value obtained by dividing the content of BaO by the content of P₂O₅.

The molar ratio (MgO+CaO+SrO+BaO)/P₂O₅ is preferably 6 or less, 4 or less, 3 or less, 2 or less, 1.5 or less, 1 or less, less than 1, 0.9 or less, or 0.8 or less, particularly preferably from 0.1 to 0.7. When the molar ratio (MgO+CaO+SrO+BaO)/P₂O₅ is too high, the thermal expansion coefficient is increased excessively. The “(MgO+CaO+SrO+BaO)/P₂O₅” refers to a value obtained by dividing the total content of MgO, CaO, SrO, and BaO by the content of P₂O₅.

ZnO is a component which increases the meltability. However, when ZnO is contained in a large amount, the glass is liable to devitrify, and in addition, the strain point is liable to be reduced. The content of ZnO is preferably from 0% to 5%, from 0% to 3%, or from 0% to 0.5%, particularly preferably from 0% to 0.2%.

TiO₂ is a component which reduces the viscosity at high temperature to improve the meltability, and is also a component which suppresses solarization. However, when TiO₂ is contained in a large amount, the glass is colored, and thus a transmittance is liable to be reduced. Accordingly, the content of TiO₂ is preferably from 0% to 3%, from 0% to 1%, or from 0% to 0.1%, particularly preferably from 0% to 0.02%.

The total content of Li₂O, Na₂O, and K₂O is from 0% to 0.5%, preferably from 0% to 0.2%, more preferably from 0% to 0.15%. When the total content of Li₂O, Na₂O, and K₂O is too large, a situation in which an alkali ion is diffused in a heat treatment step into a semiconductor substance having been formed into a film may occur.

SnO₂ is a component which exhibits a satisfactory fining action in a high temperature region. In addition, SnO₂ is a component which increases the strain point, and is also a component which reduces the viscosity at high temperature. The content of SnO₂ is preferably from 0% to 1%, from 0.001% to 1%, or from 0.05% to 0.5%, particularly preferably from 0.08% to 0.2%. When the content of SnO₂ is too large, a devitrified crystal of SnO₂ is liable to precipitate. When the content of SnO₂ is less than 0.001%, it becomes difficult to exhibit the above-mentioned effects.

SnO₂ is suitable as a fining agent, but any other fining agent than SnO₂ may be used as long as the characteristics of the glass are not significantly impaired. Specifically, As₂O₃, Sb₂O₃, CeO₂, F₂, Cl₂, SO₃, and C may be added at a total content of, for example, up to 1%, and metal powders, such as Al and Si, may be added at a total content of, for example, up to 1%.

As₂O₃ and Sb₂O₃ are excellent in fining property, but from an environmental viewpoint, it is preferred to introduce As₂O₃ and Sb₂O₃ in as small amounts as possible. Further, when As₂O₃ is contained in a large amount in the glass, solarization resistance tends to be reduced, and hence the content thereof is preferably 0.5% or less, particularly preferably 0.1% or less. It is desired that the alkali-free glass sheet be substantially free of As₂O₃. Herein, the “substantially free of As₂O₃” refers to a case in which the content of As₂O₃ in the glass composition is less than 0.05%. In addition, the content of Sb₂O₃ is preferably 1% or less, particularly preferably 0.5% or less. It is desired that the alkali-free glass sheet be substantially free of Sb₂O₃. Herein, the “substantially free of Sb₂O₃” refers to a case in which the content of Sb₂O₃ in the glass composition is less than 0.05%.

Cl has an effect of promoting the melting of the alkali-free glass sheet. When Cl is added, a reduction in melting temperature can be achieved, and the action of the fining agent is promoted. As a result, while melting cost is reduced, the lifetime of a glass manufacturing kiln can be prolonged. However, when the content of Cl is too large, the strain point is liable to be reduced. Accordingly, the content of Cl is preferably 0.5% or less, particularly preferably 0.1% or less. An alkaline earth metal chloride, such as strontium chloride, aluminum chloride, or the like may be used as a raw material for introducing Cl.

In the alkali-free glass sheet of the present invention, the contents of trace components are preferably as described below.

The content of Rh is preferably from 0.1 ppm by mass to 3 ppm by mass, from 0.2 ppm by mass to 2.5 ppm by mass, from 0.3 ppm by mass to 2 ppm by mass, or from 0.4 ppm by mass to 1.5 ppm by mass, particularly preferably from 0.5 ppm by mass to 1 ppm by mass. Rh is a component which is generally included in a melting facility. In addition, when the glass is melted at high temperature, Rh is easily eluted in a glass texture. However, when Rh and SnO₂ coexist, the glass is liable to be colored. Accordingly, the content of Rh is desirably as small as possible. The alkali-free glass according to the present invention has a relatively low viscosity in a high temperature region while having a high strain point, and hence can be melted at a lower temperature than alkali-free glass having a comparable strain point. Accordingly, the elution of Rh can be reduced more in the alkali-free glass according to the present invention than in the alkali-free glass having a comparable strain point. Moreover, when the content of Rh is reduced, high-strain-point glass can be produced without being colored at low cost.

The content of Ir is preferably from 0.01 ppm by mass to 10 ppm by mass, from 0.02 ppm by mass to 5 ppm by mass, from 0.03 ppm by mass to 3 ppm by mass, or from 0.04 ppm by mass to 2 ppm by mass, particularly preferably from 0.05 ppm by mass to 1 ppm by mass. In a melting step for the alkali-free glass sheet of the present invention, a melting facility including Ir is suitably used. Ir has higher heat resistance than Pt and a Pt—Rh alloy, and besides, can reduce bubbling at a glass interface. However, when the glass is melted in the melting facility including Ir, Ir is inevitably eluted. When the elution amount of Ir is too large, crystal stones of Ir are liable to precipitate in the glass.

The content of MoO₃ is preferably from 3 ppm by mass to 50 ppm by mass, from 4 ppm by mass to 40 ppm by mass, from 5 ppm by mass to 30 ppm by mass, or from 5 ppm by mass to 25 ppm by mass, particularly preferably from 5 ppm by mass to 20 ppm by mass. Mo is a component which is included in an electrode in the melting step. In addition, when the glass is melted through electric heating melting, MoO₃ is inevitably eluted from a Mo electrode. However, the alkali-free glass according to the present invention has a relatively low viscosity in a high temperature region while having a high strain point, and hence the elution amount of MoO₃ at the time of electric heating melting can be reduced to the extent possible.

The content of ZrO₂ is preferably from 500 ppm by mass to 2,000 ppm by mass, from 550 ppm by mass to 1,500 ppm by mass, or from 600 ppm by mass to 1,200 ppm by mass. ZrO₂ is a component which is generally included in a refractory in the melting step. In addition, when the glass is melted at high temperature, ZrO₂ is easily eluted in the glass texture. However, the alkali-free glass according to the present invention has a relatively low viscosity in a high temperature region while having a high strain point, and hence the elution amount of ZrO₂ can be reduced to the extent possible. When the elution amount of ZrO₂ is to be reduced through use of any other refractory, the use of an expensive refractory is implied, resulting in an increase in manufacturing cost. Meanwhile, when ZrO₂ is introduced in a trace amount in the glass composition, effects of reducing the liquidus temperature and improving weather resistance can be exhibited.

The alkali-free glass sheet of the present invention preferably has the following physical properties.

The density is preferably 2.50 g/cm³ or less, 2.45 g/cm³ or less, 2.40 g/cm³ or less, 2.35 g/cm³ or less, or 2.30 g/cm³ or less, particularly preferably from 2.25 g/cm³ or less. When the density is too high, the alkali-free glass sheet is liable to be deflected, and besides, it becomes difficult to achieve a reduction in weight of a device.

The average thermal expansion coefficient in a temperature range of from 30° C. to 380° C. is 34.0×10⁻⁷/° C. or less, preferably 32.0×10⁻⁷/° C. or less, 30.0×10⁻⁷/° C. or less, 27.0×10⁻⁷/° C. or less, 25.0×10⁻⁷/° C. or less, 22.0×10⁻⁷/° C. or less, 20.0×10⁻⁷/° C. or less, 19.0×10⁻⁷/° C. or less, 18.0×10⁻⁷/° C. or less, or 17.0×10⁻⁷/° C. or less, particularly preferably 10.0×10⁻⁷/° C. or more and 16.0×10⁻⁷/° C. or less. When the average thermal expansion coefficient in a temperature range of from 30° C. to 380° C. is too high, the alkali-free glass sheet is liable to have a local dimensional change owing to a temperature distribution in a film forming apparatus.

The strain point is preferably 700° C. or more, 710° C. or more, 720° C. or more, 725° C. or more, 730° C. or more, 735° C. or more, 740° C. or more, or 745° C. or more, particularly preferably from 750° C. to 900° C. When the strain point is too low, the thermal shrinkage amount of the glass is liable to be increased in manufacturing steps for a high-temperature polysilicon TFT.

The temperature at 10^{2.5} poise is preferably 1, 750° C. or less, 1, 720° C. or less, 1, 700° C. or less, 1, 690° C. or less, or 1, 680° C. or less, particularly preferably 1,670° C. or less. When the temperature at 10^{2.5} poise is too high, the meltability and the fining property are reduced, resulting in a rise in manufacturing cost.

The Young's modulus is preferably 70 GPa or more, 71 GPa or more, 72 GPa or more, 73 GPa or more, 74 GPa or more, 75 GPa or more, 76 GPa or more, 77 GPa or more, or 78 GPa or more, particularly preferably from 80 GPa to 120 GPa. When the Young's modulus is too low, the alkali-free glass sheet is liable to be deflected, and hence pattern deviation caused by stress is liable to occur in, for example, manufacturing steps for a display.

The specific Young's modulus is preferably 30 GPa/g·cm⁻³ or more, 31 GPa/g·cm⁻³ or more, or 32 GPa/g·cm⁻³ or more, particularly preferably 33 GPa/g·cm⁻³ or more. When the specific Young's modulus is too low, the deflection amount of the glass sheet is liable to be increased, and hence pattern deviation caused by stress is liable to be promoted in, for example, manufacturing steps for a display.

When a β-OH value is reduced in the alkali-free glass sheet of the present invention, the strain point can be increased. In addition, with the same glass composition, a glass sheet having a lower β-OH value can be reduced more in thermal shrinkage (low-temperature thermal shrinkage) amount in a temperature region equal to or lower than the strain point. The effect of reducing the low-temperature thermal shrinkage amount is much higher than the effect of increasing the strain point obtained by reducing the β-OH value. The β-OH value is preferably 3.0/mm or less, 2.5/mm or less, 2.0/mm or less, 1.5/mm or less, or 1.0/mm or less, particularly preferably 0.9/mm or less. When the β-OH value is too low, the meltability is liable to be reduced. Accordingly, the β-OH value is preferably 0.01/mm or more, particularly preferably 0.03/mm or more.

As a method of reducing the β-OH value, the following methods are given: (1) a method involving selecting raw materials having low water contents; (2) a method involving adding a component (such as Cl or SO₃) which reduces the β-OH value to the glass; (3) a method involving reducing the amount of water in a furnace atmosphere; (4) a method involving performing N₂ bubbling in molten glass; (5) a method involving adopting a small melting furnace; (6) a method involving increasing the flow rate of molten glass; and (7) a method involving adopting an electric melting method.

Herein, the “β-OH value” refers to a value determined using the following formula by measuring the transmittances of the glass with an FT-IR.

β-OH value=(1/X)log(T₁/T₂)

X: Thickness (mm)

T₁: Transmittance (%) at a reference wavelength of 3,846 cm⁻¹

T₂: Minimum transmittance (%) at a wavelength around a hydroxyl group absorption wavelength of 3,600 cm⁻¹

It is preferred that the alkali-free glass sheet of the present invention be formed by an overflow down-draw method. The overflow down-draw method refers to a method in which molten glass is caused to overflow from both sides of a heat-resistant trough-shaped structure, and the overflowing molten glasses are subjected to down-draw downward at the lower end of the trough-shaped structure while being joined, to thereby form a glass sheet. By the overflow down-draw method, surfaces which are to serve as the surfaces of the glass sheet are formed in a state of free surfaces without being brought into contact with the trough-shaped refractory. As a result, a glass sheet having good surface quality can be manufactured without polishing at low cost.

The forming may be performed by, for example, a slot-down method or a float method as well as the overflow down-draw method. In particular, when the glass has a low liquidus viscosity and cannot be formed by the overflow down-draw method, the glass is preferably formed by a slot-down method or a float method.

The sheet thickness of the alkali-free glass sheet of the present invention is preferably 0.7 mm or less, 0.5 mm or less, 0.4 mm or less, or 0.3 mm or less, particularly preferably from 0.05 mm to 0.1 mm. As the sheet thickness becomes smaller, a display can be reduced in weight and thickness, and further be increased in flexibility more easily.

### EXAMPLES

The present invention is hereinafter described by way of Examples. However, Examples below are merely examples, and the present invention is by no means limited to Examples below.

Examples (Sample Nos. 1 to 20) of the present invention are shown in Tables 1 and 2.

TABLE 1

| Composition | | | | | | | | | | | |
|---|---|---|---|---|---|---|---|---|---|---|---|
| (mol %) | No. 1 | No. 2 | No. 3 | No. 4 | No. 5 | No. 6 | No. 7 | No. 8 | No. 9 | No. 10 | No. 11 |
| SiO₂ | 69.9 | 69.9 | 69.9 | 69.9 | 70.9 | 71.9 | 69.9 | 68.9 | 70.9 | 69.9 | 70.9 |
| Al₂O₃ | 15.0 | 15.0 | 15.0 | 14.0 | 13.0 | 12.0 | 14.0 | 12.5 | 14.0 | 15.0 | 14.5 |
| P₂O₅ | 10.0 | 10.0 | 9.0 | 9.0 | 8.0 | 8.0 | 7.0 | 7.0 | 6.0 | 6.0 | 5.0 |
| B₂O₃ | 3.0 | 3.0 | 2.0 | 2.0 | 3.0 | 1.0 | 1.0 | 4.0 | 2.0 | 5.0 | 6.0 |
| Li₂O | 0.0 | 0.0 | 0.0 | 0.0 | 0.0 | 0.0 | 0.0 | 0.0 | 0.0 | 0.0 | 0.0 |
| Na₂O | 0.0 | 0.0 | 0.0 | 0.0 | 0.0 | 0.0 | 0.0 | 0.0 | 0.0 | 0.0 | 0.0 |
| K₂O | 0.0 | 0.0 | 0.0 | 0.0 | 0.0 | 0.0 | 0.0 | 0.0 | 0.0 | 0.0 | 0.0 |
| MgO | 1.0 | 0.5 | 0.5 | 2.5 | 1.0 | 2.0 | 3.0 | 2.0 | 1.0 | 0.5 | 3.0 |
| CaO | 1.0 | 1.5 | 3.5 | 2.5 | 4.0 | 5.0 | 5.0 | 5.0 | 6.0 | 3.5 | 0.5 |
| SrO | 0.0 | 0.0 | 0.0 | 0.0 | 0.0 | 0.0 | 0.0 | 0.5 | 0.0 | 0.0 | 0.0 |
| BaO | 0.0 | 0.0 | 0.0 | 0.0 | 0.0 | 0.0 | 0.0 | 0.0 | 0.0 | 0.0 | 0.0 |
| SnO₂ | 0.1 | 0.1 | 0.1 | 0.1 | 0.1 | 0.1 | 0.1 | 0.1 | 0.1 | 0.1 | 0.1 |
| Density (g/cm³) | 2.238 | 2.239 | 2.283 | 2.284 | 2.282 | 2.313 | 2.344 | 2.321 | 2.337 | 2.293 | 2.280 |
| αS (10⁻⁷/° C.) | 15.3 | 15.7 | 18.6 | 18.8 | 19.9 | 22.3 | 23.0 | 23.6 | 23.1 | 19.0 | 17.1 |
| Ps (° C.) | 754 | 754 | 765 | 753 | 739 | 753 | 763 | 716 | 759 | 733 | 731 |
| Ta (° C.) | 823 | 824 | 832 | 820 | 806 | 818 | 826 | 780 | 822 | 805 | 804 |
| Ts (° C.) | Unmea- | Unmea- | Unmea- | Unmea- | Unmea- | Unmea- | Unmea- | Unmea- | Unmea- | 1,115 | Unmea- |
| | sured | sured | sured | sured | sured | sured | sured | sured | sured | | sured |
| 10^{4.5} dPa · s (° C.) | Unmea- | Unmea- | Unmea- | Unmea- | Unmea- | Unmea- | Unmea- | Unmea- | Unmea- | 1,398 | Unmea- |
| | sured | sured | sured | sured | sured | sured | sured | sured | sured | | sured |
| 10^{4.0} dPa · s (° C.) | Unmea- | Unmea- | Unmea- | Unmea- | Unmea- | Unmea- | 1,485 | 1,463 | 1,480 | 1,462 | 1,448 |
| | sured | sured | sured | sured | sured | sured | | | | | |
| 10^{3.0} dPa · s (° C.) | Unmea- | Unmea- | Unmea- | Unmea- | Unmea- | Unmea- | 1,657 | 1,641 | 1,652 | 1,632 | 1,618 |
| | sured | sured | sured | sured | sured | sured | | | | | |
| 10^{2.5} dPa · s (° C.) | Unmea- | Unmea- | Unmea- | Unmea- | Unmea- | Unmea- | 1,755 | 1,752 | 1,760 | 1,739 | 1,724 |
| | sured | sured | sured | sured | sured | sured | | | | | |
| E (GPa) | 68.1 | 67.9 | 70.6 | 71.0 | 70.0 | 71.8 | 73.8 | 68.9 | 72.8 | 69.9 | 71.5 |
| E/ρ | 30.4 | 30.3 | 30.9 | 31.1 | 30.6 | 31.1 | 31.5 | 29.7 | 31.2 | 30.5 | 31.4 |
| (GPa/g · cm⁻³) | | | | | | | | | | | |
| TL (° C.) | Unmea- | Unmea- | Unmea- | Unmea- | Unmea- | Unmea- | 1,421 | 1,434 | 1,399 | 1,434 | 1,386 |
| | sured | sured | sured | sured | sured | sured | | | | | |
| Log η at TL | Unmea- | Unmea- | Unmea- | Unmea- | Unmea- | Unmea- | Unmea- | Unmea- | Unmea- | 4.2 | Unmea- |
| (dPa · s) | sured | sured | sured | sured | sured | sured | sured | sured | sured | | sured |

TABLE 2

| Composition | | | | | | | | | | | |
|---|---|---|---|---|---|---|---|---|---|---|---|
| (mol %) | No. 12 | No. 13 | No. 14 | No. 15 | No. 16 | No. 17 | No. 18 | No. 19 | No. 20 | No. 21 | No. 22 |
| SiO₂ | 70.9 | 71.9 | 69.9 | 69.9 | 69.9 | 69.9 | 70.9 | 70.9 | 70.9 | 70.0 | 67.9 |
| Al₂O₃ | 13.5 | 13.0 | 14.0 | 14.0 | 15.0 | 12.5 | 12.0 | 13.0 | 13.5 | 14.9 | 15.0 |
| P₂O₅ | 5.0 | 4.0 | 4.0 | 3.0 | 3.0 | 2.0 | 2.0 | 1.0 | 1.0 | 6.0 | 6.0 |
| B₂O₃ | 6.0 | 3.0 | 3.5 | 2.5 | 3.5 | 5.0 | 3.0 | 3.5 | 3.0 | 0.0 | 2.0 |
| Li₂O | 0.0 | 0.0 | 0.0 | 0.0 | 0.0 | 0.0 | 0.0 | 0.0 | 0.0 | 0.0 | 0.0 |
| Na₂O | 0.0 | 0.0 | 0.0 | 0.0 | 0.0 | 0.0 | 0.0 | 0.0 | 0.0 | 0.0 | 0.0 |
| K₂O | 0.0 | 0.0 | 0.0 | 0.0 | 0.0 | 0.0 | 0.0 | 0.0 | 0.0 | 0.0 | 0.0 |
| MgO | 0.5 | 5.0 | 3.0 | 5.0 | 4.0 | 3.0 | 4.0 | 3.0 | 6.0 | 3.0 | 3.0 |
| CaO | 3.5 | 2.5 | 5.0 | 5.0 | 4.5 | 6.0 | 5.0 | 5.0 | 5.0 | 6.0 | 6.0 |
| SrO | 0.5 | 0.5 | 0.5 | 0.5 | 0.0 | 0.0 | 0.0 | 0.5 | 0.5 | 0.0 | 0.0 |
| BaO | 0.0 | 0.0 | 0.0 | 0.0 | 0.0 | 1.5 | 3.0 | 3.0 | 0.0 | 0.0 | 0.0 |
| SnO₂ | 0.1 | 0.1 | 0.1 | 0.1 | 0.1 | 0.1 | 0.1 | 0.1 | 0.1 | 0.1 | 0.1 |
| Density (g/cm³) | 2.307 | 2.362 | 2.377 | 2.417 | 2.387 | 2.437 | 2.507 | 2.524 | 2.441 | 2.381 | 2.367 |
| αS (10⁻⁷/° C.) | 20.3 | 22.7 | 25.6 | 27.5 | 25.0 | 30.4 | 32.8 | 33.3 | 29.1 | 25.4 | 25.5 |
| Ps (° C.) | 714 | 739 | 730 | 740 | 736 | 713 | 725 | 732 | 739 | 775 | 744 |
| Ta (° C.) | 780 | 805 | 794 | 801 | 799 | 775 | 789 | 795 | 798 | 840 | 808 |
| Ts (° C.) | Unmea- | Unmea- | 1,062 | 1,052 | 1,054 | 1,033 | 1,049 | 1,048 | 1,039 | 1,105 | 1,072 |
| | sured | sured | | | | | | | | | |
| 10^{4.5} (° C.) | Unmea- | Unmea- | 1,348 | 1,326 | 1,327 | 1,312 | 1,335 | 1,326 | 1,300 | 1,394 | 1,359 |
| | sured | sured | | | | | | | | | |
| 10^{4.0} (° C.) | 1,459 | 1,444 | 1,414 | 1,391 | 1,390 | 1,378 | 1,402 | 1,391 | 1,362 | 1,461 | 1,426 |
| 10^{3.0} (° C.) | 1,633 | 1,617 | 1,582 | 1,556 | 1,552 | 1,548 | 1,574 | 1,558 | 1,524 | 1,630 | 1,595 |
| 10^{2.5} (° C.) | 1,742 | 1,723 | 1,688 | 1,659 | 1,653 | 1,655 | 1,683 | 1,659 | 1,626 | 1,735 | 1,698 |
| E (GPa) | 69.0 | 76.2 | 75.8 | 79.7 | 78.8 | 75.5 | 76.7 | 77.8 | 82.0 | 77.0 | 75.3 |
| E/ρ | 29.9 | 32.3 | 31.9 | 33.0 | 33.0 | 31.0 | 30.6 | 30.8 | 33.6 | 32.3 | 31.8 |
| (GPa/g · cm⁻³) | | | | | | | | | | | |
| TL (° C.) | 1,409 | 1,371 | 1,352 | 1,357 | 1,409 | 1,259 | 1,298 | 1,288 | 1,373 | 1,446 | 1,388 |
| Log η at TL | Unmea- | Unmea- | 4.5 | 4.3 | 3.9 | 5.0 | 4.8 | 4.8 | 3.9 | 4.1 | 4.3 |
| (dPa · s) | sured | sured | | | | | | | | | |

First, a glass batch prepared by blending glass raw materials so as to achieve the glass composition shown in each table was loaded in a platinum crucible, and then melted at from 1, 600° C. to 1,650° C. for 24 hours. In melting the glass batch, molten glass was stirred to be homogenized by using a platinum stirrer. Next, the molten glass was poured on a carbon sheet and formed into a sheet shape, followed by being annealed at a temperature around an annealing point for 30 minutes. Each of the resultant samples was evaluated for its density (Density), average thermal expansion coefficient (αS) in a temperature range of from 30° C. to 380° C., strain point (Ps), annealing point (Ta), softening point (Ts), temperature at a viscosity at high temperature of 10^{4.5} poise (10^{4.5} dPa·s), temperature at a viscosity at high temperature of 10^{4.0} poise (10^{4.0} dPa·s), temperature at a viscosity at high temperature of 10^{3.0} poise (10^{3.0} dPa·s), temperature at a viscosity at high temperature of 10^{2.5} poise (10^{2.5} dPa·s), Young's modulus (E), specific Young's modulus (E/ρ), liquidus temperature (TL), and liquidus viscosity (Log η at TL). In addition, part of the physical property values shown in the tables are estimate values based on the previous actually measured values.

The density is a value measured by a well-known Archimedes method.

The average thermal expansion coefficient in a temperature range of from 30° C. to 380° C. is a value measured with a dilatometer.

The strain point, the annealing point, and the softening point are values measured in accordance with methods of ASTM C336.

The temperature at a viscosity at high temperature of 10^{4.5} poise, the temperature at a viscosity at high temperature of 10^{4.0} poise, the temperature at a viscosity at high temperature of 10^{3.0} poise, and the temperature at a viscosity at high temperature of 10^{2.5} poise are each a value measured by a platinum sphere pull up method.

The Young's modulus is a value measured by a flexural resonance method.

The specific Young's modulus is a value obtained by dividing the Young's modulus by the density.

The liquidus temperature is a value obtained by placing glass powder having passed through a standard 30-mesh sieve (sieve opening: 500 μm) and remained on a 50-mesh sieve (sieve opening: 300 μm) in a platinum boat, keeping the platinum boat for 24 hours in a gradient heating furnace, and measuring a temperature at which a crystal (initial phase) precipitates. The liquidus viscosity is a value obtained by measuring a glass viscosity at the liquidus temperature TL by a platinum sphere pull up method.

As apparent from Tables 1 and 2, each of Sample Nos. 1 to 22 had a strain point of 713° C. or more and an average thermal expansion coefficient in a temperature range of from 30° C. to 380° C. of 33.3×10⁻⁷/° C. or less. Accordingly, it is considered that each of Sample Nos. 1 to 22 can remarkably reduce pattern deviation of a TFT in a high-temperature process of from 500° C. to 600° C.

1. An alkali-free glass sheet, comprising as a glass composition, in terms of mol %, 60% to 90% of SiO₂, 5% to 20% of Al₂O₃, 0% to 15% of B₂O₃, 0.1% to 20% of P₂O₅, 0% to 0.5% of Li₂O+Na₂O+K₂O, 0% to 10% of MgO, 0.1% to 10% of CaO, and 0% to 5% of SrO, and having an average thermal expansion coefficient in a temperature range of from 30° C. to 380° C. of 34.0×10⁻⁷/° C. or less.

2. The alkali-free glass sheet according to claim 1, wherein the alkali-free glass sheet has a content of SrO of 1 mol % or less.

3. The alkali-free glass sheet according to claim 1, wherein the alkali-free glass sheet has a content of B₂O₃ of 6 mol % or less.

4. The alkali-free glass sheet according to claim 1, wherein the alkali-free glass sheet has a strain point of 700° C. or more.

5. An alkali-free glass sheet, having a density of 2.50 g/cm³ or less, an average thermal expansion coefficient in a temperature range of from 30° C. to 380° C. of 34.0×10⁻⁷/° C. or less, a strain point of 700° C. or more, and a Young's modulus of 70 GPa or more.

6. The alkali-free glass sheet according to claim 2, wherein the alkali-free glass sheet has a content of B₂O₃ of 6 mol % or less.

7. The alkali-free glass sheet according to claim 2, wherein the alkali-free glass sheet has a strain point of 700° C. or more.

8. The alkali-free glass sheet according to claim 3, wherein the alkali-free glass sheet has a strain point of 700° C. or more.

9. The alkali-free glass sheet according to claim 6, wherein the alkali-free glass sheet has a strain point of 700° C. or more.
